(19) United States
(12) Patent Application Publication
(10) Pub. No.: US 2018/0061102 A1
(43) Pub. Date: Mar. 1, 2018

(54) DRIVE ASSIST DEVICE AND DRIVE ASSIST METHOD

(71) Applicant: DENSO CORPORATION, Kariya-city, Aichi-pref. (JP)

(72) Inventor: Hiroaki GOTO, Kariya-city, Aichi-pref. (JP)

(21) Appl. No.: 15/551,120

(22) PCT Filed: Jan. 28, 2016
(86) PCT No.: PCT/JP2016/052523

§ 371 Date: Aug. 15, 2017

(30) Foreign Application Priority Data
Feb. 16, 2015 (JP) 2015-027766

(51) Int. Cl. G06T 11/60; B62D 15/02; B60D 1/36; B60R 1/00

(52) U.S. Cl. CPC G06T 11/60; B62D 15/021; B62D 15/029; B60R 2300/808; B60R 1/00; B60R 2300/301; B60D 1/36

(57) ABSTRACT

A drive assist device acquires an image captured by a rear camera that captures an image in a range behind the towing vehicle, including a hitch, and superimposes a pair of left and right predicted course lines and a plurality of distance indicator lines upon the image acquired for every distance increment from the towing vehicle, for display on a display device. The drive assist device produces a superimposed display in which each distance indicator line is divided into left and right segments so as not to be superimposed upon a region corresponding to a predicted trajectory of the hitch, and end segments of the left and right segments of the distance indicator line are tilted in a zenith direction until reaching the level of the hitch for indication of the level thereof.

### TECHNICAL FIELD

The present invention relates to a drive assist technique for assisting driving when connecting a towing vehicle to a towed vehicle.

### BACKGROUND ART

Drive assist devices based on conventional art are known to include ones that assist driving when connecting a towing vehicle to a towed vehicle. For example, PTL 1 discloses a drive assist device configured as follows. The drive assist device of PTL 1 produces a superimposed display in which a predicted trajectory of the hitch (connector of towing vehicle) mounted to the rear of a towing vehicle and the trajectory, i.e. a vertical projection of the predicted trajectory on the road surface, are superimposed upon an image captured by a rear-view camera. Further, in superimposed display produced by the drive assist device of PTL 1, vertical lines each indicating the level of the connector of the towed vehicle, as a connection destination of the hitch, are also superimposed upon the image captured by the rear-view camera.

PTL 2 discloses a drive assist device configured as follows. The drive assist device of PTL 2 produces a superimposed display in which predicted trajectory guide marks of the hitch at the rear of the towing vehicle are superimposed upon an image captured behind the towing vehicle. In this case, the image includes the hitch and the connector of the towed vehicle to be connected to the hitch. Specifically, the drive assist device of PTL 2 produces a superimposed display in which a pair of left and right planar predicted trajectory guide marks corresponding to the steering of the towing vehicle is superimposed upon the image behind the towing vehicle such that the movement path of the hitch is blanked.

### CITATION LIST

### [Patent Literature]

[PTL 1]: JP 2002-308029 A

[PTL 2]: WO 2012/117693

### SUMMARY OF THE INVENTION

### [Technical Problem]

In the drive assist device of PTL 1, the predicted trajectory of the hitch and the vertical lines each indicating the level of the connector of the towed vehicle, as a connection destination of the hitch, are displayed being superimposed upon the image of the connector of the towed vehicle. Therefore, in the drive assist device of PTL 1, a good view of the connector of the towed vehicle is not easily obtained, and visibility is poor accordingly. Thus, the drive assist device of PTL 1 suffers from difficulty in aligning the hitch with the connector of the towed vehicle.

Regarding the drive assist device of PTL 2, use of only the planar predicted trajectory guide marks is insufficient to know the height from the road surface. Therefore, in the drive assist device of PTL 2, it is difficult for the driver to immediately recognize the positional relationship between the planar predicted trajectory guide marks and the connector of the towed vehicle in the vehicle width direction. Thus, the drive assist device of PTL 2 suffers from difficulty in aligning the hitch with the connector of the towed vehicle.

The present disclosure has an object to provide a drive assist technique of facilitating alignment between the hitch of a towing vehicle and the connector of a towed vehicle when connecting the towing vehicle to the towed vehicle.

### [Solution to Problem]

A drive assist device of the present disclosure is mounted to a towing vehicle which is provided with a hitch at a rear to establish a connection with a connector of a towed vehicle. The drive assist device of the present disclosure includes an image acquisition means and a display processing means. The image acquisition means acquires an image captured by a camera that captures an image within a predetermined range behind the towing vehicle, including the hitch. The display processing means superimposes at least one distance indicator line upon the image acquired by the image acquisition means for every distance increment from the towing vehicle, for display on a display device. The distance indicator line extends in a vehicle width direction with respect to a predicted course of the towing vehicle to indicate an index of a distance from the towing vehicle. In the drive assist device, the display processing means produces a superimposed display in which the distance indicator line is divided into left and right segments so as not to be superimposed upon a region corresponding to a predicted trajectory of the hitch, with part or all of the left and right segments indicating a level of the hitch.

The drive assist device of the present disclosure produces a superimposed display in which a plurality of distance indicator lines provided for every change of distance from a towing vehicle are superimposed upon an image captured by a rear camera in a predetermined range behind the towing vehicle, including the hitch. Thus, with the drive assist device of the present disclosure, the driver can easily recognize the clearance between the hitch and the connector of a towed vehicle. The drive assist device of the present disclosure produces a superimposed display in which each distance indicator line is divided into left and right segments so as not to be superimposed upon (so as to create a blank in) a region corresponding to a predicted trajectory of the hitch of the towing vehicle. Thus, the driver can drive the towing vehicle such that the region corresponding to the predicted trajectory of the hitch of the towing vehicle (blank region of the image with no superimposition) aligns with the connector of the towed vehicle. In the drive assist device of the present disclosure, the region corresponding to the predicted trajectory of the hitch with no superimposition (the blank) ensures good visibility without causing any difficulty in seeing the connector of the towed vehicle. Accordingly, the drive assist device of the present disclosure facilitates alignment between the hitch and the connector of the towed vehicle. The drive assist device of the present disclosure produces a superimposed display such that all or part of left and right segments of each distance indicator line indicates the level of the hitch of the towing vehicle. Thus, the driver can immediately recognize the positional relationship between the hitch and the connector of the towed vehicle, compared to the case of not indicating the level of the hitch of the towing vehicle. In this way, the drive assist device of the present disclosure can facilitate alignment between the hitch and the connector of the towed vehicle.

### BRIEF DESCRIPTION OF THE DRAWINGS

FIG. 1 is a block diagram outlining an example of a configuration of a drive assist system, according to a first embodiment.

FIG. 2 is a diagram illustrating an example of a superimposition image, according to the first embodiment.

FIG. 3 is a flow chart illustrating an example of image display processing for connection assist performed by the drive assist device, according to a first embodiment.

FIG. 4 is a diagram illustrating an example of a connection assist image in which a superimposition image is superimposed upon a rear-view image, according to the first embodiment.

FIG. 5 is a diagram illustrating an example of a superimposition image, according to a modification.

FIG. 6 is a diagram illustrating an example of a superimposition image, according to a modification.

FIG. 7 is a diagram illustrating an example of a superimposition image, according to a modification.

FIG. 8 is a block diagram outlining an example of a configuration of a drive assist system, according to a modification.

### DESCRIPTION OF EMBODIMENTS

### First Embodiment

### <Outline of Drive Assist System>

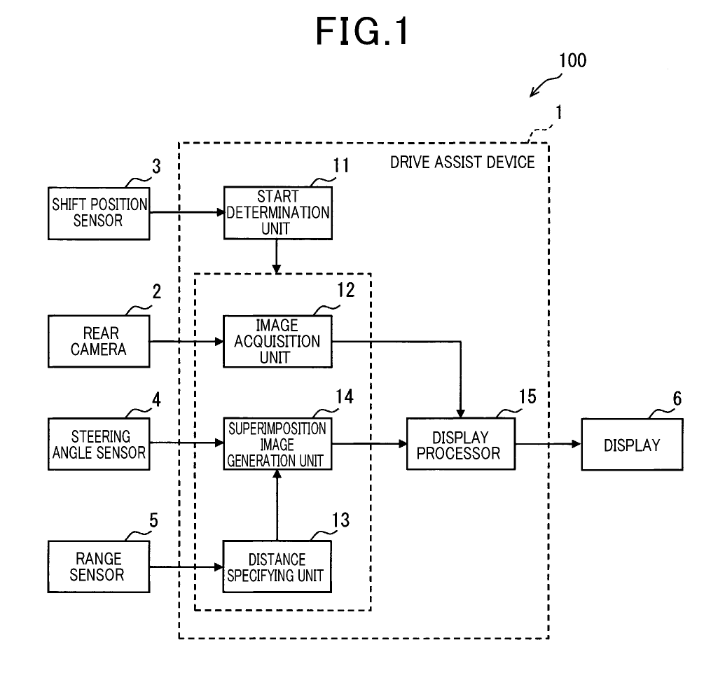

With reference to the drawings, some embodiments of a drive assist device of the present disclosure will be described below. FIG. 1 is a block diagram outlining an example of a configuration of a drive assist system 100 to which a drive assist device of the present disclosure is applied. As shown in FIG. 1, the drive assist system 100 of the present embodiment is mounted to a towing vehicle, and includes a drive assist device 1, a rear camera 2, a shift position sensor 3, a steering angle sensor 4, a range sensor 5, and a display 6.

The towing vehicle herein refers to a vehicle for pulling a towed vehicle, such as a boat trailer or a camper trailer. The towing vehicle connects the hitch (connector of towing vehicle) provided to the rear thereof to the connector of a towed vehicle to pull the towed vehicle.

The rear camera 2 is arranged above the hitch. The rear camera 2 is arranged such that its imaging axis is oriented to the road surface. The rear camera 2 arranged in this way captures an image behind the towing vehicle, including the hitch. The rear camera 2 captures an image of a region extending, centering on the optical axis, over a range of a predetermined imaging angle in the rearward direction of the towing vehicle. The rear camera 2 generates image data of a captured image (hereinafter referred to as rear-view image, for the sake of convenience) and outputs the generated image data to the drive assist device 1. In the present embodiment, examples of the rear camera 2 that can be used include a CCD camera, a CMOS image sensor, and a near-infrared camera.

The shift position sensor 3 detects a shift position (gear position) of the towing vehicle and outputs the detection result (signal indicating the detected shift position). The steering angle sensor 4 detects a steering angle of the towing vehicle. The present embodiment is described by way of an example in which a steering angle is detected by the steering angle sensor 4.

The range sensor 5 transmits search waves over a predetermined range and receives the search waves reflected from an object to detect a distance from the position where the sensor is arranged to the object. The range sensor 5 is arranged at the rear of the towing vehicle. The range sensor 5 is arranged such that its optical axis having directivity is oriented to a rearward direction of the towing vehicle. The range sensor 5 arranged in this way is used for detecting a towed vehicle located behind the towing vehicle. The range sensor 5 of the present embodiment may use sound waves or radio waves, instead of light waves. In the present embodiment, examples of the range sensor 5 that can be used include sonar, laser radar, and millimeter wave radar.

The display 6 displays an image in a predetermined display region according to an instruction from the drive assist device 1. As the display 6 of the present embodiment, a liquid crystal display capable of full color display, for example, may be used.

The drive assist device 1 of the present embodiment is provided with a CPU, a memory (ROM, RAM, etc.), and I/O, which are all connected via a bus. In the drive assist device 1, the CPU executes a program stored in the memory. With the execution of the program, the drive assist device 1 of the present embodiment performs image display processing to assist connecting the towing vehicle to the towed vehicle. As a result of the image display processing, the drive assist device 1 displays a connection assist image on the display 6 to thereby exert a drive assist function for connecting the towing vehicle to the towed vehicle. In the drive assist device 1 of the present disclosure, all or part of the functions exerted by the execution of the program may be configured to be achieved by one or more hardware components (e.g., an IC).

### <Outline of Drive Assist Device 1>

As shown in FIG. 1, the drive assist device 1 of the present embodiment is provided with a start determination unit 11, an image acquisition unit 12, a distance specifying unit 13, a superimposition image generation unit 14, and a display processor 15.

The start determination unit 11 determines whether to start the image display processing for assisting connection of the towing vehicle to the towed vehicle. The start determination unit 11 determines to start the image display processing when the shift position detected by the shift position sensor 3 is at the backward position corresponding to the position for instructing backward movement of the vehicle (i.e., reverse R position). In the drive assist device 1 of the present embodiment, when the start determination unit 11 determines to start the image display processing, processes are performed by the image acquisition unit 12, the distance specifying unit 13, and the superimposition image generation unit 14.

The present embodiment may be so configured that the processes are performed by the acquisition unit 12, the distance specifying unit 13, and the superimposition image generation unit 14 before it is determined whether to start the image display processing. However, from the perspective of reducing power consumption and processing load of the drive assist device 1, the processes are preferably performed when the image display processing is already started.

The image acquisition unit 12 sequentially acquires rear-view images captured by the rear camera 2. The image acquisition unit 12 outputs the acquired rear-view images to the display processor 15. The image acquisition unit 12 serves as an image acquisition means acquiring an image captured by the rear camera 2 which is a camera for capturing an image within a predetermined range behind the towing vehicle, including the hitch.

The distance specifying unit 13 specifies a distance from the towing vehicle to a towed vehicle (hereinafter referred to as clearance), based on a detection signal of the range sensor 5. The distance specifying unit 13 serves as a distance specifying means specifying a clearance between the towing vehicle and the towed vehicle by using the range sensor 5. The range sensor 5 detects the presence of an obstacle in the transmission direction of the search waves, based on the reception intensity of the waves reflected from an object. Accordingly, in the present embodiment, the obstacle detected behind the towing vehicle, i.e. detected in the transmission direction of the search waves, is estimated to be a towed vehicle. The distance specifying unit 13 specifies the distance from the towing vehicle to the towed vehicle, based on the time from the transmission of the search waves to the reception of the waves reflected from the towed vehicle.

The superimposition image generation unit 14 generates a superimposition image to be displayed, being superimposed upon a rear-view image. The superimposition image generation unit 14 outputs the generated superimposition image to the display processor 15. The superimposition image generation unit 14 generates a superimposition image including a pair of left and right predicted course lines of the towing vehicle and a distance indicator line that is an index of a distance from the towing vehicle, on the basis of the clearance specified by the distance specifying unit 13, the steering angle of the towing vehicle detected by the steering angle sensor 4, and the like. Further, the superimposition image generation unit 14 generates a superimposition image including the predicted course lines and the distance indicator line, on the basis of the arrangement position of the hitch, parameters of the rear camera 2 (e.g., information on the arrangement position and the image capture direction), and the like. In the present embodiment, the arrangement position of the hitch and the parameters of the rear camera 2 are served by data stored in advance in a predetermined storage area, such as a non-volatile memory provided to the drive assist device 1.

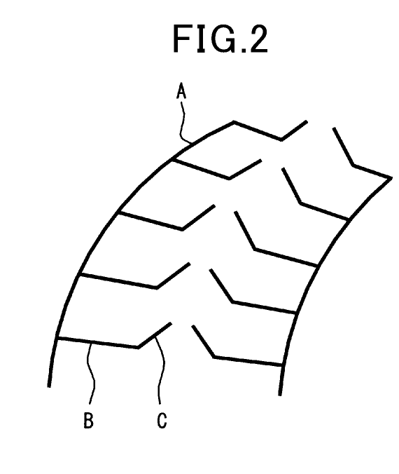

FIG. 2 illustrates an example of the superimposition image generated by the superimposition image generation unit 14. Specifically, FIG. 2 illustrates a superimposition image including predicted course lines A and a distance indicator line B. Further, FIG. 2 shows that the distance indicator line B includes end segments C which indicate information on the level of the hitch of the towing vehicle.

The predicted course lines A are the vehicle trajectories along which the towing vehicle is predicted to pass during backward movement. For example, the predicted course lines A are the trajectories that the rear left and rear right corners of the towing vehicle are predicted to pass. The predicted course lines A are calculated by the following method. In the present embodiment, for example, a turn radius R of the towing vehicle is calculated by the following Relational Expression (1):

R=L/tanθ (1)

where O is the turn center that is on a line extended from the rear-wheel axle shaft of the towing vehicle, θ is the steering angle of the towing vehicle, and L is the wheelbase of the towing vehicle. In the present embodiment, using the calculated turn radius R as a basis, the pair of left and right predicted course lines A corresponding to the steering angle θ (steering) are calculated. The method of calculating the predicted course lines A is not limited to the one mentioned above.

For example, using the steering angle 0 and the vehicle speed V of the towing vehicle as a basis, arc trajectories of the outermost and innermost circumferences of the towing vehicle may be calculated first, and then the predicted course lines A may be calculated based on the calculated arc trajectories of the outermost and innermost circumferences. Other methods may be used for calculating the predicted course lines A.

In the present embodiment, the calculated predicted course lines A should fall within the range of the clearance between the towing vehicle and the towed vehicle. The predicted course lines A should be in a range not exceeding the clearance between the towing vehicle and the towed vehicle. Accordingly, for example, the predicted course lines A may be shorter than the clearance between the towing vehicle and the towed vehicle.

The superimposition image generation unit 14 performs perspective transformation for the pair of left and right predicted course lines A of the towing vehicle on the ground plane calculated by the above method. In the perspective transformation, the parameters of the rear camera 2 are used. Specifically, the superimposition image generation unit 14 transforms the pair of left and right predicted course lines A of the towing vehicle into a pair, in terms of the viewpoint of the rear camera 2.

The distance indicator line B serves as an index of a distance from the towing vehicle. The distance indicator line B is provided in the superimposition image so as to extend in a vehicle width direction relative to the predicted course lines A. A plurality of distance indicator lines B are provided between the pair of left and right predicted course lines A (two lines) at regular intervals in a direction departing from the towing vehicle (provided for every change of distance from the towing vehicle). For example, the interval may be 50 cm, 1 m, or the like. As shown in FIG. 2, the present embodiment is described by way of an example in which the distance indicator lines B are provided in a superimposition image so as to extend in the vehicle width direction from the pair of left and right predicted course lines A. However, the way of providing the distance indicator lines B should not be taken as a limiting sense. The distance indicator lines B may be provided, for example, so as to extend outward intersecting the pair of left and right predicted course lines A.

Each distance indicator line B is divided into left and right two segments so as not to produce a display in which the distance indicator line B is superimposed upon a region corresponding to a predicted trajectory of the hitch of the towing vehicle (so as to produce a display in which a blank is created in the region). The predicted trajectory of the hitch of the towing vehicle is calculated by the same method as that of calculating the predicted course lines A, based on the steering angle θ of the towing vehicle detected by the steering angle sensor 4 and the arrangement position of the hitch of the towing vehicle.

Further, each distance indicator line B includes information on the level of the hitch of the towing vehicle. In the present embodiment, each distance indicator line B is divided into left and right segments with a blank therebetween. The left and right segments have respective ends (two ends) facing each other and having respective segments of a predetermined length. The predetermined length expressed by these segments (segment length) of the distance indicator line B corresponds to the end segments C indicating the information on the level of the hitch of the towing vehicle. The end segments C of each distance indicator line B are each tilted by an angle gentler than a right angle in a higher-level direction (hereinafter referred to as zenith direction) using an end of the segment as a pivot, until reaching the level of the hitch of the towing vehicle to thereby indicate the level of the hitch of the towing vehicle. The level of the hitch, based on which the end segments C are tilted, may be specified based on the arrangement position of the hitch of the towing vehicle.

A width between the face-to-face ends of the left and right segments of each distance indicator line B (blank width between the two indicator segments of each distance indicator line B) is ensured to appear wider at position further from the towing vehicle, when displayed on the display 6. The width between the face-to-face ends of each distance indicator line B closest to the towing vehicle is rendered to be approximately the same as the width of the hitch of the towing vehicle. In the drive assist device 1 of the present embodiment, the distance enabling easier correction of the displacement between the hitch and the connector of the towed vehicle (clearance between the towing vehicle and the towed vehicle) through driving manipulation permits the width (blank width) between the face-to-face ends of the distance indicator line B to appear wider. Consequently, in the drive assist device 1 of the present embodiment, the driver can easily know the degree of correction for the displacement between the hitch and the connector of the towed vehicle.

In the present embodiment, the distance indicator line B should fall within the range of the clearance between the towing vehicle and the towed vehicle. The distance indicator line B should be in a range of not exceeding the clearance between the towing vehicle and the towed vehicle. Accordingly, for example, the distance indicator line B may be shorter than the clearance between the towing vehicle and the towed vehicle.

The superimposition image generation unit 14 also performs perspective transformation for the distance indicator line B, using the parameters of the rear camera 2. Specifically, the superimposition image generation unit 14 transforms the distance indicator line B into a distance indicator line B from the towing vehicle in terms of the viewpoint of the rear camera 2. As a result, the level of the hitch of the towing vehicle indicated by the end segments C (tilt of the segments) of the distance indicator line B appears to be higher, as the distance indicator line B is at position closer to the towing vehicle. The display form of the distance indicator lines B may be modified for the driver's easier recognition by, for example, changing the color of the line closest to the towing vehicle, or blinking the line closest to the towing vehicle.

The display processor 15 displays the rear-view image acquired by the image acquisition unit 12 on the display 6. In this case, the display processor 15 superimposes the superimposition image generated by the superimposition image generation unit 14 upon the rear-view image to provide the superimposed image as a connection assist image, for superimposed display on the display 6. The display processor 15 serves as a display processing means superimposing the distance indicator line B, which extends in the vehicle width direction relative to the predicted course of the towing vehicle, upon a captured image for every change of distance from the towing vehicle, and displaying the superimposed image on the display 6.

### <Image Display Processing for Connection Assist>

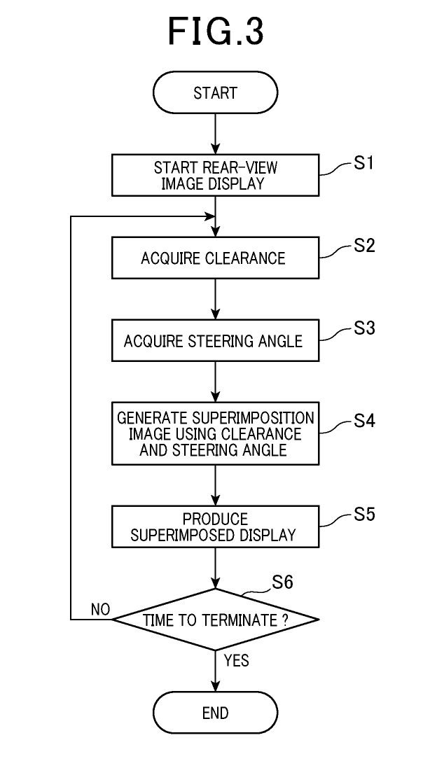

Subsequently, referring to FIG. 3, the following description addresses a flow of image display processing for connection assist performed by the drive assist device 1 of the present embodiment. The processing shown in FIG. 3 is performed when, for example, the shift position of the towing vehicle is brought to a backward position and the start determination unit 11 determines to start the image display processing for connection assist.

In the drive assist device 1 of the present embodiment, the image acquisition unit 12 starts acquisition of the rear-view image from the rear camera 2. Then, in the drive assist device 1, the display processor 15 starts display of the rear-view image acquired by the image acquisition unit 12 on the display 6 (step S1).

In the drive assist device 1, the superimposition image generation unit 14 acquires a clearance (distance between the towing vehicle and the towed vehicle) specified by the distance specifying unit 13 (step S2). The superimposition image generation unit 14 acquires a steering angle θ of the towing vehicle detected by the steering angle sensor 4 (step S3). The superimposition image generation unit 14 generates a superimposition image (see FIG. 2) including predicted course lines A and distance indicator lines B, based on the clearance acquired at step S2 and the steering angle θ of the towing vehicle acquired at step S3 (step S4). In this case, the superimposition image generation unit 14 reads the data stored in advance in a predetermined storage area and generates a superimposition image, based on the arrangement position of the hitch of the towing vehicle and the parameters of the rear camera 2.

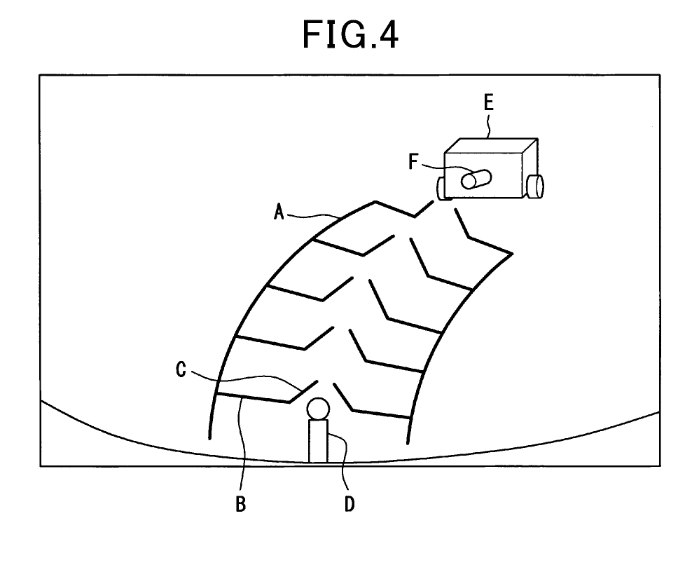

In the drive assist device 1, the display processor 15 superimposes the superimposition image generated at step S4 upon the rear-view image displayed at step S1. Then, the display processor 15 provides the superimposed image as a connection assist image, for superimposed display on the display 6 (step S5). Referring to FIG. 4, the following description addresses a display example of superimposing the superimposition image upon a rear-view image and providing the superimposed image as a connection assist image, for superimposed display on the display 6. Specifically, FIG. 4 shows a display example of superimposing the superimposition image including predicted course lines A, distance indicator lines B, and end segments C, upon a rear-view image including a hitch D of the towing vehicle, a towed vehicle E, and a connector F of the towed vehicle E. In this case, the end segments C indicate information on the level of the hitch D in the respective distance indicator lines B.

In the image obtained by superimposing the superimposition image upon the rear-view image, the predicted course lines A are displayed so as to appear at the road surface level. The segments contacting the respective predicted course lines A (segments different from the end segments C) in each distance indicator line B are displayed so as to appear at the road surface level. The end segments C of each distance indicator line B, which are tilted in the zenith direction by an angle gentler than the right angle, are displayed so as to indicate the level of the hitch D of the towing vehicle. Each distance indicator line B is displayed being divided into left and right segments so as not to produce a display in which the distance indicator line B is superimposed upon the region corresponding to a predicted trajectory of the hitch D of the towing vehicle (so as to produce a display in which a blank is created in the region). Further, the predicted course lines A and the distance indicator lines B are displayed within the range of the clearance between the towing vehicle and the towed vehicle E. Thus, the predicted course lines A and the distance indicator lines B are displayed so as not to go beyond the position of the towed vehicle E and not to overlap the towed vehicle E.

Referring to FIG. 3 again, the drive assist device 1 determines whether the time has come to terminate the image display processing for connection assist (step S6). If it is determined that time has come to terminate the processing (YES at step S6), the drive assist device 1 terminates the image display processing for connection assist. If the drive assist device 1 determines that time has not come yet to terminate the processing (NO at step S6), control returns to step S2 to repeat (continue) the image display processing for connection assist. The timing of terminating the image display processing for connection assist may be, for example, the time point when the ignition power supply of the towing vehicle is turned off, or the time point when the shift position is brought to a position other than the backward position (other than the reverse R position).

When the time has not yet come to terminate the processing and when control returns to step S2 from step S6 to repeat the image display processing for connection assist (NO at step S6), the following image is displayed, for example. The drive assist device 1 generates a new superimposition image according to the steering angle θ detected by the steering angle sensor 4 and the clearance specified by the distance specifying unit 13 every time the processing is repeated, for superimposed display in the rear-view image. In this case as well, the predicted course lines A and the distance indicator lines B are displayed within the range of the clearance between the towing vehicle and the towed vehicle E. Therefore, the drive assist device 1 sequentially eliminates from display (hides) the predicted course lines A and the distance indicator lines B at position further from the towing vehicle, as the towing vehicle comes closer to the towed vehicle E (as the clearance decreases).

### <Overview of First Embodiment>

In the drive assist device 1 of the present embodiment, the display processor 15 produces a superimposed display in which the plurality of distance indicator lines B are superimposed upon the rear-view image behind the towing vehicle, including the hitch D, for every change of distance from the towing vehicle. Thus, the drive assist device 1 enables driver's easy recognition of the distance between the hitch D of the towing vehicle and the connector F of the towed vehicle E.

In the drive assist device 1 of the present embodiment, the display processor 15 produces a superimposed display in which each distance indicator line B is divided into left and right segments so as not to be superimposed upon the region corresponding to the predicted trajectory of the hitch D of the towing vehicle (so as to create a blank in the region). Thus, the driver can drive the towing vehicle such that the region corresponding to the predicted trajectory of the hitch D of the towing vehicle (blank region in the image with no superimposition) is brought to a position suitable for mating with the connector F of the towed vehicle, thereby aligning the hitch D of the towing vehicle with the connector F of the towed vehicle E.

In the drive assist device 1 of the present embodiment, the display processor 15 causes no superimposition in the region corresponding to the predicted trajectory of the hitch D of the towing vehicle. Thus, the drive assist device 1 causes no trouble in obtaining a good view of the connector F of the towed vehicle E, i.e. ensures good visibility. With good visibility being ensured, the driver can easily align the hitch D of the towing vehicle with the connector F of the towed vehicle E.

In the drive assist device 1 of the present embodiment, the display processor 15 tilts the end segments C of each distance indicator line B by an angle gentler than the right angle in the zenith direction until reaching the level of the hitch D, for superimposed display of the level of the hitch D of the towing vehicle. Thus, the drive assist device 1 easily enables the driver's immediate recognition of the positional relationship between the hitch D and the connector F of the towed vehicle E, comparing to the display not indicating the level of the hitch D of the towing vehicle. Thus, the driver can easily align the hitch D of the towing vehicle with the connector F of the towed vehicle E.

In the drive assist device 1 of the present embodiment, the display processor 15 produces a superimposed display of the predicted course lines A and the distance indicator lines B so as to fall within the range of the clearance between the towing vehicle and the towed vehicle E. Thus, the drive assist device 1 prevents the predicted course lines A and the distance indicator lines B from going beyond the position of the towed vehicle E and thus from being visually recognized as overlapping the towed vehicle E, thereby minimizing complication of the display.

### (Modification 1)

The above embodiment has been described by way of an example of producing a display pattern of a superimposition image in which the level of the hitch D of the towing vehicle is indicated by tilting the end segments C of the distance indicator lines B by an angle gentler than the right angle in the zenith direction until reaching the level of the hitch D. This display pattern of the superimposition image, however, should not be construed as a limiting sense.

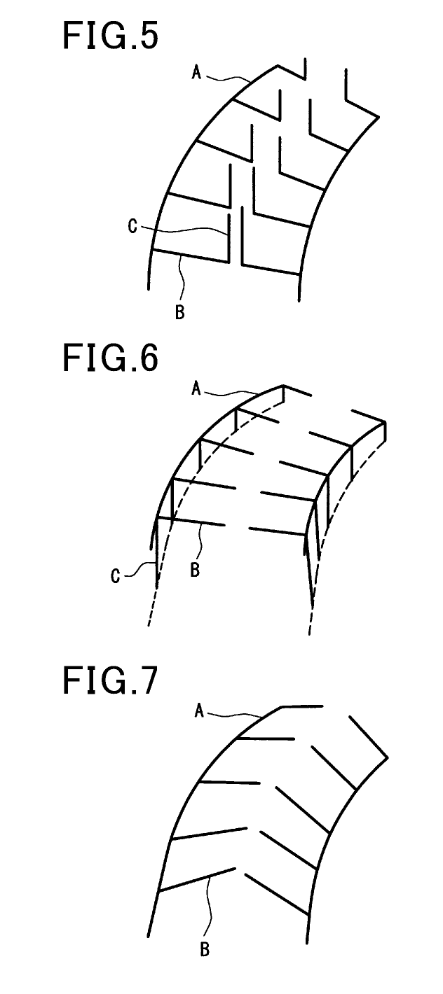

For example, as shown in FIG. 5, another display pattern of a superimposition image may be produced. In the display pattern shown in FIG. 5, the predicted course lines A and the segments of each distance indicator line B contacting the respective predicted course lines A (segments different from the end segments C) are provided at the road surface level. Further, in each distance indicator line B, the level of the hitch D of the towing vehicle may be indicated by tilting the end segments C, not contacting the predicted course lines A, by the right angle in the zenith direction until reaching the level of the hitch D.

In addition, as shown in FIG. 6, another display pattern of a superimposition image may be produced. In the display pattern shown in FIG. 6, the predicted course lines A and the segments of each distance indicator line B contacting the respective predicted course lines A (segments different from the end segments C) are provided at the level of the hitch D of the towing vehicle. Further, in each distance indicator lines B, the level of the hitch D of the towing vehicle may be indicated by tilting at right angle the end segments C in a lower-level direction (hereinafter referred to as road surface direction for the sake of convenience) until reaching the road surface level, using the points contacting the predicted course lines A as pivots. The broken lines of FIG. 6 do not have to be displayed in practice. As a modification of FIG. 6, the end segments C of each distance indicator line B may be tilted from the points contacting the respective predicted course lines A toward the road surface by an angle gentler than the right angle. In each distance indicator line B, the end segments C, not contacting the respective predicted course lines A, may be tilted toward the road surface by an angle gentler than the right angle. In any of the examples, the drive assist device 1 produces a display in which the distance indicator lines B are not superimposed upon (blank is created in) the region corresponding to the predicted trajectory of the hitch D of the towing vehicle.

### (Modification 2)

As shown in FIG. 7, in another display pattern of a superimposition image, the predicted course lines A may be provided at the road surface level. Further, one of both ends of each distance indicator lines B may be tilted by an angle gentler than the right angle in the zenith direction, while contacting the predicted course line A, until reaching the level of the hitch D to thereby indicate the level of the hitch D. In this example as well, the drive assist device 1 produces a display in which the distance indicator lines B are not superimposed upon (a blank is created in) the region corresponding to the predicted trajectory of the hitch D of the towing vehicle.

### (Modification 3)

The drive assist device 1 may be configured such that (hereinafter referred to as Modification 3) the user (e.g., the driver) can select (switch) a display pattern to be superimposed upon the rear-view image, from among a plurality of display patterns as shown, for example, in Modifications 1 and 2.

Modification 3 will be described below with reference to the drawings. For the sake of clarity, in describing Modification 3, like reference signs are given to members having functions similar to those of the members described (shown in the drawings) so far to omit duplicate description.

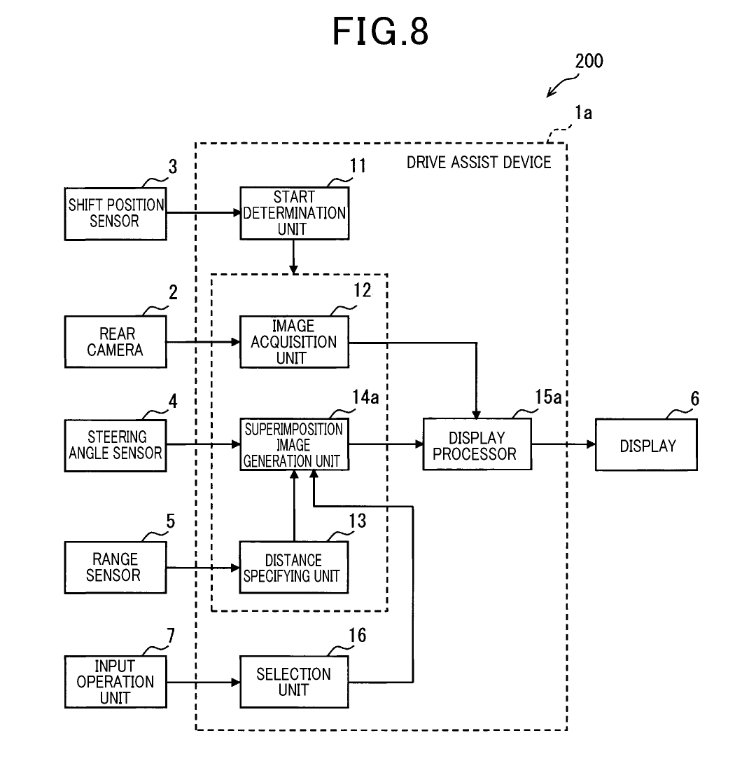

As shown in FIG. 8, a drive assist system 200 according to Modification 3 is provided with a drive assist device 1a, the rear camera 2, the shift position sensor 3, the steering angle sensor 4, the range sensor 5, the display 6, and an input operation unit 7. The drive assist system 200 of Modification 3 is similar to the drive assist system 100 of the above embodiments except that the system 200 includes the input operation unit 7 and also includes the drive assist device 1a instead of the drive assist device 1.

The input operation unit 7 of Modification 3 receives user's operation for various settings related to drive assist. The input operation unit 7 includes a user interface, such as buttons or switches. The user interface provided to the input operation unit 7 may be a hardware interface, such as mechanical buttons or switches, or may be a software interface. Modification 3 will be described assuming that the input operation unit 7 includes, as the user interface, a software interface, such as touch buttons or touch switches integrated with the display 6.

As shown in FIG. 8, the drive assist device 1a of Modification 3 includes the start determination unit 11, the image acquisition unit 12, the distance specifying unit 13, a superimposition image generation unit 14a, a display processor 15a, and a selection unit 16. The drive assist device 1a is similar to the drive assist device 1 of the above embodiments except that the device 1a includes the selection unit 16, and includes the superimposition image generation unit 14a and the display processor 15a instead of the superimposition image generation unit 14 and the display processor 15, respectively.

The display processor 15a of Modification 3 displays on the display 6 a selection screen for selecting a display pattern to be superimposed upon a rear-view image from among a plurality of display patterns of a superimposition image. The display processor 15a may be configured to display a selection screen of the display patterns when a user's instruction for displaying a selection screen is received through the input operation unit 7 in a state where, for example, the power supply for the drive assist device 1a is turned on.

The input operation unit 7 of Modification 3 receives a user's operation input for selection of a display pattern of the superimposition image to be superimposed upon the rear-view image, when an input operation is performed with respect to the displayed selection screen. The input operation unit 7 outputs information on the received operation input to the selection unit 16. The selection unit 16 of Modification 3 selects (switches) the display pattern to be superimposed upon the rear-view image from among a plurality of display patterns of the superimposition image, according to the operation input received by the input operation unit 7.

The selection unit 16 serves as a selection means selecting a display pattern indicating the level of the hitch D of the towing vehicle from among the plurality of display patterns, according to the user's operation input.

When the image display processing for connection assist is started, the superimposition image generation unit 14a of Modification 3 generates a superimposition image to be superimposed upon a rear-view image, according to the display pattern selected by the selection unit 16. The superimposition image generation unit 14a is similar to the superimposition image generation unit 14 of the first embodiment except that the unit 14a generates a superimposition image according to the display pattern selected by the selection unit 16. That is, the superimposition image generation unit 14a of Modification 3 generates a superimposition image on the basis of the steering angle θ detected by the steering angle sensor 4 and the clearance specified by the distance specifying unit 13.

Similarly to the above embodiments, the display processor 15a of Modification 3 displays a rear-view image acquired by the image acquisition unit 12 on the display 6 when the image display processing for connection assist is started. The display processor 15a superimposes the superimposition image generated by the superimposition image generation unit 14a upon a rear-view image to produce a superimposed display on the display 6 in which the superimposed image is displayed as a connection assist image.

With the above configuration of the drive assist device 1a of Modification 3, the user can select a display pattern of a superimposition image to thereby produce a superimposed display in which a desired superimposition image is superimposed upon a rear-view image (produce a desired connection assist image).

### (Modification 4)

The drive assist devices 1 and 1a of the embodiments and the modifications described above may be configured to enable adjustments such as of the following various values. Specifically, the adjustments may be conducted according to the user's operation input for the intervals of the distance indicator lines B to be displayed, the width between the face-to-face ends (blank width) of each distance indicator line B, the level of the hitch D of the towing vehicle indicated by all or part of each distance indicator line B, and the like in the superimposition image.

### (Modification 5)

In the configurations of the embodiments described above, the distance specifying unit 13 has specified the clearance between the towing vehicle and the towed vehicle E by using the range sensor 5. However, the method of specifying the clearance between the towing vehicle and the towed vehicle E is not limited to this. For example, the method of specifying the clearance between the towing vehicle and the towed vehicle E may be configured such that the distance specifying unit 13 specifies the clearance, based on the image captured by the rear camera 2. In this case, the distance specifying unit 13 performs predetermined image recognition processing, such as edge detection and template matching, with respect to a rear-view image to thereby detect the towed vehicle E included in the rear-view image. The distance specifying unit 13 should then specify the clearance, based on the position of the towed vehicle E in the rear-view image and the parameters of the rear camera 2.

### (Modification 6)

In the configurations of the embodiments described above, the drive assist device 1 has changed the range of displaying the predicted course lines A and the distance indicator lines B, based on the clearance between the towing vehicle and the towed vehicle E specified by the distance specifying unit 13. However, the display produced of the predicted course lines A and the distance indicator lines B is not limited to this. For example, the predicted course lines A and the distance indicator lines B may be configured to be displayed, irrespective of the distance between the towing vehicle and the towed vehicle E, without providing the distance specifying unit 13 to the drive assist device 1. In this case, the drive assist device 1 may be configured to display the predicted course lines A and the distance indicator lines B within a range of a predetermined distance from the towing vehicle.

### (Modification 7)

The predicted course lines A do not have to be necessarily displayed. In this case, instead of displaying the pair of left and right predicted course lines A, the drive assist device 1 may be configured to display the distance indicator lines B such that the driver can recognize the location of the predicted course lines A from the widths of the respective distance indicator lines B.

The drive assist devices 1 and 1a of the present disclosure are not limited to the embodiments described above but various modifications are available within the technical scope of the present disclosure. The technical scope of the present disclosure encompasses not only the embodiments of the drive assist devices 1 and la described above, but also the embodiments obtained by appropriately combining the technical means disclosed in the above embodiments.

### REFERENCE SIGNS LIST

1, 1a: Drive assist device,
2: Rear camera (camera),
5: Range sensor,
6: Display (display device),
11: Start determination unit,
12: Image acquisition unit,
13: Distance specifying unit,
15, 15a: Display processor,
16: Selection unit,
100, 200: Drive assist system.

1. A drive assist device mounted to a towing vehicle which is provided with a hitch at a rear to establish a connection with a connector of a towed vehicle, the device comprising:
an image acquisition means acquiring an image captured by a camera that captures an image within a predetermined range behind the towing vehicle, including the hitch; and
a display processing means superimposing at least one distance indicator line upon the image acquired by the image acquisition means for every distance increment from the towing vehicle, for display on a display device, the distance indicator line extending in a vehicle width direction with respect to a predicted course of the towing vehicle to indicate an index of a distance from the towing vehicle, wherein
the display processing means produces a superimposed display in which the distance indicator line is divided into left and right segments so as not to be superimposed upon a region corresponding to a predicted trajectory of the hitch, with part or all of the left and right segments indicating a level of the hitch.

2. The drive assist device according to claim 1, further comprising:
a plurality of display patterns of a superimposed image with different indications in the level of the hitch; and
a selection means selecting a display pattern indicating the level of the hitch from among the plurality of display patterns, according to an operation input of a user, wherein
the display processing means produces the superimposed display in which the superimposition image is superimposed upon the image, according to the display pattern selected by the selection means.

3. The drive assist device according to claim 1, wherein the display processing means indicates the level of the hitch by tilting end segments of the respective left and right segments of the distance indicator line in the same higher-level direction.

4. The drive assist device according to claim 1, wherein the display processing means indicates the level of the hitch by tilting the entire left and right segments of the distance indicator line in the same higher-level direction.

5. The drive assist device according to claim 1, wherein the left and right face-to-face ends of the distance indicator line have a width therebetween which is displayed on the display device so as to appear wider at points further from the towing vehicle.

6. The drive assist device according to claim 1, wherein the level of the hitch indicated by the distance indicator lines is displayed on the display device so as to appear higher at point closer to the towing vehicle.

7. The drive assist device according to claim 1, wherein the display processing means produces the superimposed display in which a pair of left and right predicted course lines indicating the predicted course of the towing vehicle is superimposed upon the image acquired by the image acquisition means.

8. The drive assist device according to claim 1, further comprising:
a distance specifying means specifying a distance from the towing vehicle to the towed vehicle using a sensor, wherein
the display processing means allows the superimposed display, in which the distance indicator lines are superimposed upon the image acquired by the image acquisition means, to fall within a range of the distance specified by the distance specifying means.

9. The drive assist device according to claim 8, wherein, as the distance specified by distance specifying means becomes shorter, the display processing means sequentially hides the distance indicator lines, starting from one located further from the towing vehicle, so that the superimposed display, in which the distance indicator lines are superimposed upon the image, falls within the range of the distance specified by the distance specifying means.

10. A drive assist method for a drive assist device mounted to a towing vehicle which is provided with a hitch at a rear to establish a connection with a connector of a towed vehicle, the method comprising:
an image acquisition step acquiring an image captured by a camera that captures an image within a predetermined range behind the towing vehicle, including the hitch; and
a display processing step superimposing at least one distance indicator line upon the image acquired in the image acquisition step for every distance increment from the towing vehicle, for display on a display device, the distance indicator line extending in a vehicle width direction with respect to a predicted course of the towing vehicle to indicate an index of a distance from the towing vehicle, wherein
the display processing step produces a superimposed display in which the distance indicator line is divided into left and right segments so as not to be superimposed upon a region corresponding to a predicted trajectory of the hitch, with part or all of the left and right segments indicating a level of the hitch.
